(19) United States
(12) Patent Application Publication
(10) Pub. No.: US 2009/0073589 A1
(43) Pub. Date: Mar. 19, 2009

(54) Frame Comprising A Vibration-Damping Device, Which Is Intended For The Outside Rear-View Mirror Assembly Of A Motor Vehicle

(76) Inventors: Jose Mendoza Vicioso, Santa Agnes De Malanyanes (La Roca Del (ES); Ismael Ayestaran Velazquez, Terrassa (ES)

Correspondence Address: RATNERPRESTIA, P.O. BOX 980, VALLEY FORGE, PA, 19482, US

(21) Appl. No.: 11/792,802

(22) PCT Filed: Dec. 20, 2004
(86) PCT No.: PCT/IB04/04210

§ 371 Date: May 7, 2008

(51) Int. Cl. B60R 1/06

(52) U.S. Cl. 359/872

(57) ABSTRACT

The invention relates to a frame comprising a vibration-damping device, which is intended for the outside rear-view mirror assembly of a motor vehicle. According to the invention, a moving plate bearing a mirror is connected to the inventive frame by means of a knuckle-type joint. Optionally, a case is installed on the frame in order to house a position-adjustment mechanism which is connected to the moving plate and which is actuated in order to vary the position of the plate in relation to two co-ordinate axes. According to the invention, a tab, which projects out from part of the moving plate opposite the frame, is pressed such that it can slide through a damping arrangement comprising a pair of elastic arms which form part of the frame and which extend therefrom. The aforementioned elastic arms are arranged in the form of a clamp in order to form a pressure contact against the opposing faces of the tab.

### FIELD OF THE ART

The present invention relates to a frame comprising a vibration-damping device which is intended for the outside rear-view mirror assembly of a motor vehicle, and more particularly to a frame which can be obtained by injection molding and integrates a damping device forming part of said vibration-damping device in a same part.

### PRIOR STATE OF THE ART

Outside rear-view mirrors for motor vehicles comprising a frame secured to the vehicle and a moving plate to which mirror is fixed are well known. The moving plate is connected to said frame by means of a kinematic knuckle-type joint providing it with a freedom of rotation in relation to two mutually perpendicular axes that are generally parallel to the reflecting surface of the mirror. Both axes cross one another at a point forming the center of both rotations and which is therefore immobile, the joining point for joining the moving plate to the support structure is therefore located in said center. The rear-view mirror generally includes an adjustment mechanism formed by actuation and movement transmission means, assembled in a case supported on the frame for example. The transmission means have moving elements connected to two points of the moving plate separated from the joining point. An activation of the mentioned actuation and transmission means selectively moves the connection points of the moving plate and thus provides it with a swiveling movement on said two co-ordinate axes for the purpose of selecting a position adjusted to the needs of a user.

The incorporation of a damping arrangement in the form of a metallic elastic clamp fixed to the frame by means of a screw or other joining means is known for the purpose of damping possible vibrations transmitted to the moving plate, which clamp acts by securing by pressure a tab such that it can slide, which tab projects out from the moving plate. This clamp is usually a standard part on the market, manufactured in stainless steel for springs, and can be assembled both in metal and plastic frames, whereas the tab forms part of the moving plate and is generally obtained by the injection molding of a plastic or thermoplastic material.

However, this vibration-damping device based on a metal clamp fixed to the frame has several drawbacks. Firstly, it has a relatively high economic cost, given that the clamp made of stainless steel for springs has a high cost and it further involves multiple components making the storage, logistic and assembly operations expensive. Furthermore, these multiple components and their assembly operation increase the risk of failures which may affect the reliability of the product. On the other hand, the frictional contact between the clamp and the tab can cause an unpleasant metallic nose, which normally forces the application of grease during the assembly. Finally, the different materials of which the multiple parts i.e., frame, clamp, screw, etc., are made makes the recycling of the assembly at the end of its useful life difficult.

Alternatively, utility model ES-A-1054454 discloses a vibration-damping device incorporating a single damping arm which forms part of a part forming the frame, and has a free end in permanent contact with a surface of a flexible tab projecting out from the moving plate. However, although this contact on a single side of the tab can neutralize most vibration frequencies, it favors some harmonics translating into a deficient vibration damping. The material normally used for manufacturing the moving plate furthermore does not ensure the elasticity and becomes unstable over time, especially at under medium or high temperatures. For this reason, the result can be an insufficient damping, which can even be nil, after a certain time of exposure of the tab to climatic factors.

### EXPLANATION OF THE INVENTION

The present invention contributes to solving the previous and other drawbacks by providing a frame comprising a vibration-damping device, which is intended for the outside rear-view mirror assembly of a motor vehicle, said frame being of the type which is adapted to support a moving plate bearing at least one mirror, which plate is connected to the frame by means of a knuckle-type joint allowing a combined swiveling on two co-ordinate axes, where a tab projecting out from the moving plate is pressed such that it can slide through a damping arrangement joined to the frame for the purpose of damping vibrations. The frame of the present invention is characterized in that said damping arrangement comprises at least one pair of elastic arms which form part of the frame and form a single part therewith, said elastic arms being arranged in the form of a clamp in order to form a pressure contact against the opposing faces of said tab.

According to one embodiment, the mentioned elastic arms in the form of a clamp extend from the frame and have respective mutually opposite free ends separated by a distance less than a thickness of said tab. The frame is suitably configured so as to be obtained by injection molding, preferably of a plastic or thermoplastic material. This construction can cover most applications, given that currently about 80% of the support frames of rear-view mirrors of motor vehicles are carried out by molding a plastic material. The elasticity of the arms is determined by the thickness of their cross-section in combination with the features of the selected material. The arms of the clamp can thus have a substantially elastic behavior whereas the frame is substantially rigid, despite being of the same material.

The materials having suitable elasticity and climatic stability features for manufacturing the inventive frame include simple materials such as, for example, PA (polyamide), PP (polypropylene), PBT (polybutylene terephthalate), or POM (polyoxymethylene polyformaldehyde (polyacetal)); or any of the previous materials including a load of FG (fiberglass for example); or mixed materials such as for example, ABS+PC (acrylonitrile-butadiene-styrene+polycarbonate).

The frame of the present invention provides multiple advantages. The damping arrangement and the frame integrated in a single part provide an important economic saving due to the reduction of components and the subsequent elimination of the corresponding assembly operations. Furthermore, the general reliability of the rear-view mirror is thus increased as the risk of failure due to assembly defects is eliminated. Furthermore, possible metallic noises are thus prevented and the recycling is made easier to a great extent.

### BRIEF DESCRIPTION OF THE DRAWINGS

The previous and other advantages and features shall be more fully understood from the following detailed description of an embodiment with reference to the attached drawings, in which:

FIG. 1 shows a partially sectioned side elevational view of a frame comprising a vibration-damping device according to the closest state of the art, coupled to a moving plate bearing a mirror;

FIG. 2 shows a partially sectioned side elevational view of a frame comprising a vibration-damping device according to an embodiment of the present invention, coupled to a moving plate bearing a mirror; and

FIG. 3 shows a plan view of the frame of FIG. 2.

### DETAILED DESCRIPTION OF AN EMBODIMENT

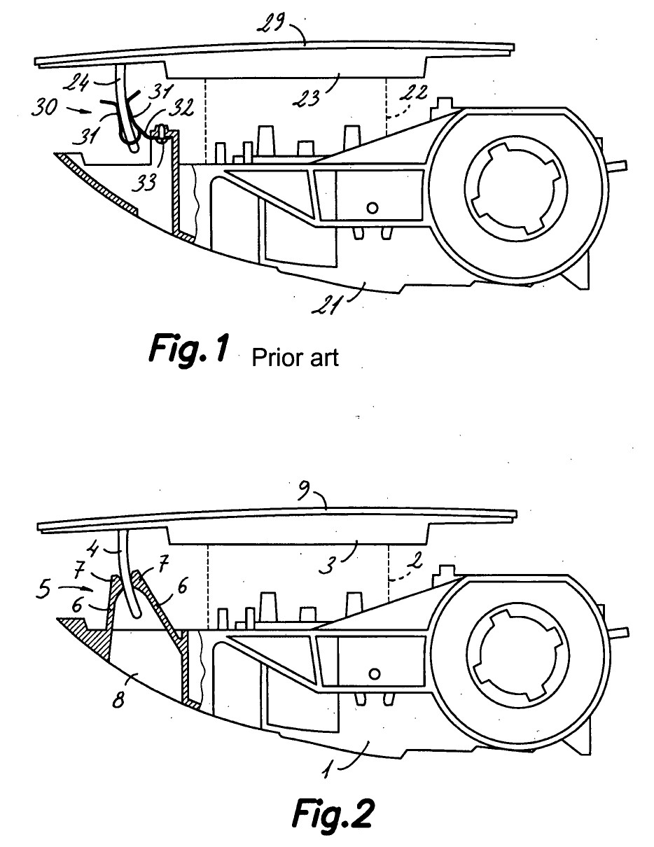

With reference to FIG. 1, it shows a frame 21 comprising a vibration-damping device, which is intended for the outside rear-view mirror assembly of a motor vehicle, according to the state of the art. The mentioned frame 21 is adapted to support a moving plate 23 to which there is fixed at least one mirror 29. Said moving plate 23 is assembled by means of a knuckle-type joint allowing a combined swiveling of the moving plate 23 on two co-ordinate axes. A case is generally installed on the frame 21, which case houses an adjustment mechanism comprising movement transmission means connected to the moving plate 23 in order to vary its position. The case housing said adjustment mechanism and the mentioned knuckle-type joint are conventional and have been schematically shown as a whole by means of dotted lines 22 in FIG. 1.

The moving plate 23 incorporates a tab 24 projecting out from a lower part of such plate opposite the frame 21 for the purpose of damping a possible vibration transmission from the frame 21 to the moving plate 23. Said tab 24 is adapted to be pressed such that it can slide in a damping arrangement 25 joined to the frame 1. In this frame of the state of the art, the mentioned damping arrangement 25 comprises an elastic clamp 30 manufactured from a sheet of stainless steel for springs. The mentioned clamp 30 comprises a par of arms 31 adapted to press against both faces of the tab 24 and an appendage 32 through which the clamp 30 is fixed to the frame 21 by means of a screw 33 or another equivalent joining means.

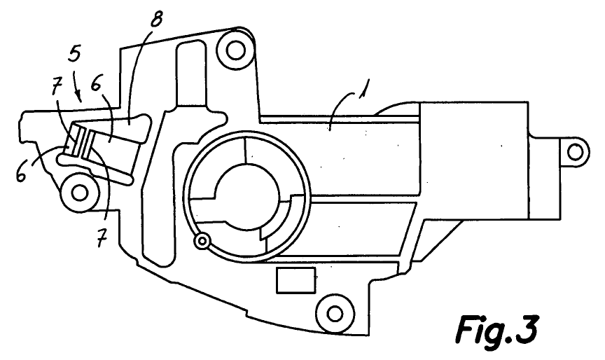

FIGS. 2 and 3 shows a frame 1 comprising a vibration-damping device, which is intended for the outside rear-view mirror assembly of a motor vehicle according to the present invention, which incorporates a new damping arrangement 5 designed to palliate some of the drawbacks of the metallic elastic clamp 30 of the state of the art, set forth above.

In a manner similar to the frame 21 of the state of the art descried above in relation to FIG. 1, the mentioned frame 1 according to the present invention is adapted to support a moving plate 3 bearing at least one mirror 9. This moving plate 3 is connected to the frame 1 by means of a knuckle-type joint allowing a combined swiveling of the moving plate 3 on two co-ordinate axes. Optionally, a case can be installed on the frame 1, which case houses a position-adjustment mechanism including movement transmission means connected to the moving plate in order to vary its position. The actuation of the mentioned movement transmission means can be any of the different types that are well known in the art of the sector. Given that the arrangement of the adjustment mechanism and of the mentioned knuckle-type joint is conventional and does not form part of the object of the present invention, its detailed description will be omitted and its representation will be jointly and schematically indicated by means of a case 2 in dotted lines in FIG. 2.

It must only be stated, by way of an illustrative example, that the actuation of the position-adjustment mechanism can be carried out by one or two electric motors included in the mentioned case 2, or by one or more electric motors located in a separate place and connected by means of a transmission by flexible cables to the means of case 2, or by manually operated controls connected to the means of case 2 by flexible cables or another movement transmission. However, the adjustment mechanism is not essential because rear-view mirror assemblies are also known in which such adjustment mechanism has been omitted and in which the position of the moving plate 3 is directly varied manually. This is the case, for example, of relatively large rear-view mirrors for vans and industrial vehicles in which the moving plate is simply supported by the knuckle-type joint, in which the vibration-damping device can be a determining factor. Therefore, the case 2 shown schematically in dotted lines of FIG. 2 is meant to indicate both a simple knuckle-type joint and a knuckle-type joint in combination with an adjustment mechanism.

Continuing with FIGS. 2 and 3, a tab 4, which projects out from a part of the moving plate 3 opposite the frame 1, is pressed such that it can slide through a damping arrangement 5 joined to the frame 1 object of the present invention. This damping arrangement 5 comprises at least one pair of elastic arms 6 arranged in the form of a clamp in order to form a pressure contact against the opposing faces of said tab 4. It must be emphasized that the mentioned elastic arms 6 form part of the frame 1, i.e. the frame 1 and the elastic arms 6 are formed from a single part, which is suitable configured so as to be obtained by injection molding, preferably of plastic or thermoplastic material. The elastic arms 6 extend from the frame 1 to the moving plate 3 and have respective mutually opposite free ends 7 separated by a distance less than a thickness of said tab 4, such that the tab 4 causes a slight elastic deformation of the elastic arms 6 which ensures a pressure contact. The degree of elasticity of the elastic arms 6 can be suitably adapted to the requirements of its vibration-damping function by selecting a cross-sectional area of the elastic arms 6 according to several features of the material of the part forming the frame 1. The tab has a curved configuration with a center of curvature substantially located at a crosspoint of the mentioned two co-ordinate axes, i.e., in the swiveling center of the knuckle-type joint.

According to the embodiment shown in FIGS. 2 and 3, the elastic arms 6 arise from inner walls of a through hole 8 from one side of the frame 1 to the other and are inclined in opposite directions converging towards said free ends 7, which ends gave opposite projections defining respective contact surfaces with the tab 4.

A person skilled in the art can introduce variations and modifications in the shown and described embodiment without departing from the scope of the present invention as it is defined in the attached claims.

1. A frame comprising a vibration-damping device which is intended for the outside rear-view mirror assembly of a motor vehicle, said frame being of the type adapted to support a moving plate bearing at least one mirror and connected to the frame by means of a knuckle-type joint allowing a combined swiveling on two co-ordinate axes, in which a tab which projects out from the moving plate is pressed such that it can slide through a damping arrangement joined to the frame for the purpose of damping vibrations, said damping arrangement comprising at least one pair of elastic arms which form part of the frame and form a single part therewith, said elastic arms being arranged in the form of a clamp in order to form a pressure contact against the opposing faces of said tab.

2. A frame according to claim 1, said elastic arms extend from the frame and have respective mutually opposite free ends separated by a distance less than a thickness of said tabs.

3. A frame according to claim 2, wherein said elastic arms are inclined in opposite directions converging towards said free ends.

4. A frame according to claim 3, wherein the free ends of the elastic arms have opposite projections defining respective contact surfaces with the tab.

5. A frame according to claim 3, wherein the elastic arms extend from inner walls of a hole formed in the frame.

6. A frame according to claim 5, wherein said hole a through hole extending from one side of the frame to the other.

7. A frame according to claim 1, wherein said elastic arms have a cross-sectional area selected according to several features of the material of the part forming the frame to determine an elasticity of the elastic arms adapted for damping vibrations.

8. A frame according to claim 1, further comprising a support for a case housing a position-adjustment mechanism connected to the moving plates, said mechanism being actuated in order to vary the position of the moving plate in relation to said co-ordinate axes.

9. A frame according to claim 1, wherein it is configured to be formed by injection molding.

10. A frame according to claim 1, wherein it is configured to be formed by the injection molding of a plastic or thermoplastic material.
